(19) United States
(12) Patent Application Publication
(10) Pub. No.: US 2025/0138714 A1
(43) Pub. Date: May 1, 2025

(54) SYSTEMS, APPARATUSES, METHODS, AND COMPUTER PROGRAM PRODUCTS FOR A STABILIZED AVIATION OPERATIONS INTERFACE COMPONENT

(71) Applicant: Honeywell International Inc., Charlotte, NC (US)

(72) Inventors: Kalimulla Khan, Bangalore (IN); Kirupakar J, Madurai (IN); Kenneth M. Leiphon, Phoenix, AZ (US); Mythili Belle Kamath, Bangalore (IN); Ramkumar Rajendran, Madurai (IN)

(21) Appl. No.: 18/921,887

(22) Filed: Oct. 21, 2024

Related U.S. Application Data
(60) Provisional application No. 63/593,860, filed on Oct. 27, 2023.

(30) Foreign Application Priority Data
Jul. 18, 2024 (IN) 202411054939

(51) Int. Cl. G06F 3/04845; B64D 45/00

(52) U.S. Cl. CPC G06F 3/04845; B64D 45/00

(57) ABSTRACT

Systems, apparatuses, methods, and computer program products are provided herein. For example, a method may include receiving aviation operations display data associated with an aircraft. In some embodiments, the method includes capturing aviation operations impact data using one or more aircraft components of the aircraft. In some embodiments, the aviation operations impact data is indicative of an aviation instability event. In some embodiments, the method includes generating aviation stability adjustment data by applying the aviation operations impact data to an aviation stability adjustment model. In some embodiments, the method includes generating a stabilized aviation operations interface component based on the aviation stability adjustment data and the aviation operations display data. In some embodiments, the method includes causing the stabilized aviation operations interface component to be rendered to an aviation operations interface of a device.

### CROSS REFERENCE TO RELATED APPLICATIONS

This application claims the benefit of U.S. Provisional Patent Application No. 63/593,860, filed Oct. 27, 2023 and India Provisional Patent Application No. 202411054939, filed Jul. 18, 2024, the entire contents of which are incorporated by reference herein.

### TECHNOLOGICAL FIELD

Embodiments of the present disclosure relate generally to systems, apparatuses, methods, and computer program products for a stabilized aviation operations interface component.

### BACKGROUND

Applicant has identified many technical challenges and difficulties associated with unstable aviation interface components. Through applied effort, ingenuity, and innovation, Applicant has solved problems related to unstable aviation interface components by developing solutions embodied in the present disclosure, which are described in detail below.

### BRIEF SUMMARY

Various embodiments described herein relate to systems, apparatuses, methods, and computer program products for a stabilized aviation operations interface component.

In accordance with one aspect of the disclosure, a method is provided. In some embodiments, the method includes receiving aviation operations display data associated with an aircraft. In some embodiments, the method includes capturing aviation operations impact data using one or more aircraft components of the aircraft. In some embodiments, the aviation operations impact data is indicative of an aviation instability event. In some embodiments, the method includes generating aviation stability adjustment data by applying the aviation operations impact data to an aviation stability adjustment model. In some embodiments, the method includes generating a stabilized aviation operations interface component based on the aviation stability adjustment data and the aviation operations display data. In some embodiments, the stabilized aviation operations interface component comprises one or more stabilized aviation operations display items. In some embodiments, the method includes causing the stabilized aviation operations interface component to be rendered to an aviation operations interface of a device.

In some embodiments, the aviation operations interface comprises one or more touch zones.

In some embodiments, the stabilized aviation operations interface component comprises one or more remapped touch zones.

In some embodiments, the method includes identifying predicted aviation operations impact data.

In some embodiments, the method includes determining that the aircraft is predicted to be impacted by the aviation instability event based on the predicted aviation operations impact data.

In some embodiments, the method includes identifying aviation operations data.

In some embodiments, the method includes generating an aviation operations interface component based on the aviation operations data.

In some embodiments, the aviation operations interface component comprises one or more aviation operations display items.

In some embodiments, the method includes causing the aviation operations interface component to be rendered on the aviation operations interface.

In some embodiments, the aviation instability event is one or more of a landing associated with the aircraft, a takeoff associated with the aircraft, weather associated with the aircraft, or turbulence associated with the aircraft.

In some embodiments, the aviation operations impact data is captured when the aircraft is performing an aviation mission.

In some embodiments, the device is a flight management system, an electronic flight bag, or a multi-function control and display unit.

In some embodiments, the device is physically secured to the aircraft.

In some embodiments, the aviation stability adjustment data is representative of an estimated position change of an eye gaze of an operator of the aircraft.

In some embodiments, the aviation stability adjustment data is representative of an estimated position change of the device.

In accordance with another aspect of the disclosure, an apparatus is provided. In some embodiments, the apparatus includes memory and one or more processors communicatively coupled to the memory. In some embodiments, the one or more processors are configured to receiving aviation operations display data associated with an aircraft. In some embodiments, the one or more processors are configured to capturing aviation operations impact data using one or more aircraft components of the aircraft. In some embodiments, the aviation operations impact data is indicative of an aviation instability event. In some embodiments, the one or more processors are configured to generating aviation stability adjustment data by applying the aviation operations impact data to an aviation stability adjustment model. In some embodiments, the one or more processors are configured to generating a stabilized aviation operations interface component based on the aviation stability adjustment data and the aviation operations display data. In some embodiments, the stabilized aviation operations interface component comprises one or more stabilized aviation operations display items. In some embodiments, the one or more processors are configured to causing the stabilized aviation operations interface component to be rendered to an aviation operations interface of a device.

In some embodiments, the aviation operations interface comprises one or more touch zones.

In some embodiments, the stabilized aviation operations interface component comprises one or more remapped touch zones.

In some embodiments, the one or more processors are configured to identify predicted aviation operations impact data.

In some embodiments, the one or more processors are configured to determine that the aircraft is predicted to be impacted by the aviation instability event based on the predicted aviation operations impact data.

In some embodiments, the one or more processors are configured to identify aviation operations data.

In some embodiments, the one or more processors are configured to generate an aviation operations interface component based on the aviation operations data.

In some embodiments, the aviation operations interface component comprises one or more aviation operations display items.

In some embodiments, the one or more processors are configured to cause the aviation operations interface component to be rendered on the aviation operations interface.

In some embodiments, the aviation instability event is one or more of a landing associated with the aircraft, a takeoff associated with the aircraft, weather associated with the aircraft, or turbulence associated with the aircraft.

In some embodiments, the device is a flight management system, an electronic flight bag, or a multi-function control and display unit.

In some embodiments, the aviation stability adjustment data is representative of an estimated position change of an eye gaze of an operator of the aircraft.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for receiving aviation operations display data associated with an aircraft. In some embodiments, the computer program code, in execution with at least one processor, configures the computer program product for capturing aviation operations impact data using one or more aircraft components of the aircraft. In some embodiments, the aviation operations impact data is indicative of an aviation instability event. In some embodiments, the computer program code, in execution with at least one processor, configures the computer program product for generating aviation stability adjustment data by applying the aviation operations impact data to an aviation stability adjustment model. In some embodiments, the computer program code, in execution with at least one processor, configures the computer program product for generating a stabilized aviation operations interface component based on the aviation stability adjustment data and the aviation operations display data. In some embodiments, the stabilized aviation operations interface component comprises one or more stabilized aviation operations display items. In some embodiments, the computer program code, in execution with at least one processor, configures the computer program product for causing the stabilized aviation operations interface component to be rendered to an aviation operations interface of a device.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates an example interface component in accordance with one or more embodiments of the present disclosure;

FIG. 4 illustrates an example interface component in accordance with one or more embodiments of the present disclosure;

FIG. 5 illustrates a flowchart of an example method in accordance with one or more embodiments of the present disclosure; and

FIG. 6 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with unstable aviation interface components. As would be understood by one skilled in the field to which this disclosure pertains, there are numerous example scenarios in which aviation interface components are desirable.

In many applications it may be desirable to use aviation interface components, such as an aviation interface component associated with a flight management system of an aircraft. For example, it may be desirable to use an aviation interface component to facilitate an aviation mission (e.g., moving from one airport to another airport) associated with an aircraft in a safe, efficient, and accurate manner. In some implementations, aviation interface components and/or aircraft associated with aviation interface components are impacted by aviation instability events. For example, aviation interface components and/or aircraft associated with aviation interface components may be impacted by aviation instability events that include weather, turbulence, landing, taking off, and/or the like.

In some implementations, an aviation instability event may decrease the usefulness of aviation interface components because such aviation interface components become unstable (e.g., an aviation interface component may shake due to an aviation instability event). For example, an aviation instability event may cause aviation interface components to become unstable such that information displayed on the aviation interface component is not readable by an operator of an aircraft (e.g., a pilot). As another example, an aviation instability event may cause aviation interface components to become unstable such that an operator of an aircraft is unable to use aviation interface components to carry out an aviation mission (e.g., cause an aircraft to change altitude). As another example, an aviation instability event may cause aviation interface components to become unstable such that an operator of an aircraft is affected by motion sickness due to the shaking of the aviation interface components. Accordingly, there is a need for systems, apparatuses, methods, and computer program products for generating a stabilized aviation operations interface even when aviation interface components and/or aircraft are impacted by an aviation instability event.

Thus, to address these and/or other issues related to aviation interface components, example systems, apparatuses, methods, and computer program products for generating a stabilized aviation operations interface component are disclosed herein. For example, an embodiment in this disclosure, described in greater detail below, includes a method that includes receiving aviation operations display data associated with an aircraft. In some embodiments, the method includes capturing aviation operations impact data using one or more aircraft components of the aircraft. In some embodiments, the aviation operations impact data is indicative of an aviation instability event. In some embodiments, the method includes generating aviation stability adjustment data by applying the aviation operations impact data to an aviation stability adjustment model. In some embodiments, the method includes generating a stabilized aviation operations interface component based on the aviation stability adjustment data and the aviation operations display data. In some embodiments, the method includes causing the stabilized aviation operations interface component to be rendered to an aviation operations interface of a device. Accordingly, the systems, apparatuses, methods, and computer program products for a stabilized aviation operations interface component provided herein enable a stabilized aviation operations interface even when aviation interface components and/or aircraft are impacted by an aviation instability event.

### Example Systems and Apparatuses

Embodiments of the present disclosure herein include systems, apparatuses, methods, and computer program products configured for generating a stabilized aviation operations interface component. It should be readily appreciated that the embodiments of the apparatus, systems, methods, and computer program product described herein may be configured in various additional and alternative manners in addition to those expressly described herein.

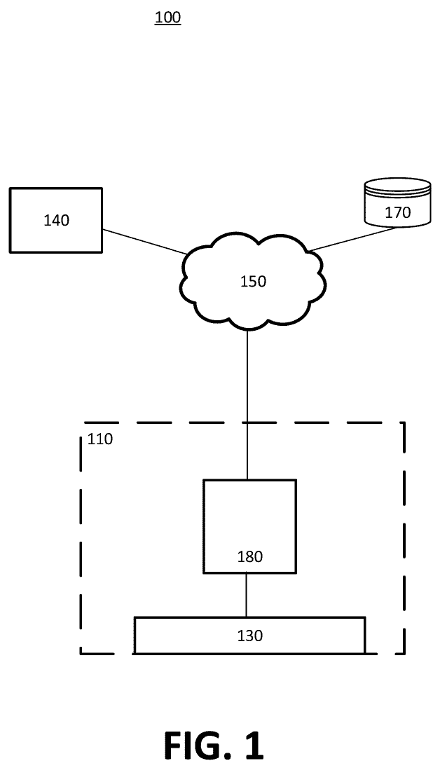

FIG. 1 illustrates an example block diagram of an environment 100 in which embodiments of the present disclosure may operate. Specifically, FIG. 1 illustrates an aircraft 110. In some embodiments, the aircraft 110 may describe any machine, robot, computing devices, and/or apparatus comprised of hardware, software, firmware, and/or any combination thereof, that maneuvers throughout an environment through a medium, such as air. In some contexts, the aircraft 110 is utilized to transport objects, entities (e.g., people, animals, or other beings), and/or other onboard cargo. In some situations, the aircraft 110 may be transporting no object except for the aircraft itself. Examples of the aircraft 110 include airplanes, helicopters, drones, and/or the like. In some embodiments, the aircraft 110 is not limited to the examples listed herein and may include other types of transportation device.

In some embodiments, the aircraft 110 is configured to perform an aviation mission. In some embodiments, an aviation mission is a defined series of operations performed by the aircraft 110. For example, may include a defined series of operations performed by the aircraft 110 to move from a first airport to a second airport. In this regard, in some embodiments, an aviation mission may include a defined series of operations performed by the aircraft 110 that include operations performed while the aircraft 110 is performing preflight procedures, (e.g., at the gate before a flight), leaving a gate, taxiing, taking off, in flight, landing, parking at a gate performing post flight procedures (e.g., at the gate after a flight), and/or the like. For example, an aviation mission may include a defined series of operations that includes leaving the gate at a first airport, taxiing to a runway at the first airport (e.g., an originating airport), taking off from the first airport, flying to a second airport (e.g., a destination airport), landing at the second airport, taxiing to a gate at the second airport, parking at a gate at the second airport.

In some embodiments, the aircraft 110 is associated with a determinable location. The determinable location of the aircraft 110 in some embodiments represents an absolute position (e.g., GPS coordinates, latitude and longitude locations, an address, and/or the like) or a relative position of the aircraft 110 (e.g., an identifier representing the location of the aircraft 110 as compared to one or more other aircraft, one or more buildings (e.g., an airport), an enterprise headquarters, or general description in the world for example based at least in part on continent, state, ocean, or other definable region). In some embodiments, the aircraft 110 includes or otherwise is associated with a location sensor and/or software-driven location services that provide the location data corresponding to the aircraft 110. In other embodiments, the location of the aircraft 110 is stored and/or otherwise determinable to one or more systems.

In some embodiments, the environment 100 includes an external aviation stabilization device 140. In some embodiments, the external aviation stabilization device 140 is electronically and/or communicatively coupled to the aircraft 110, the onboard aviation stabilization device 180, the one or more aircraft components 130, and/or the one or more databases 170. The external aviation stabilization device 140 may be located remotely from the aircraft 110. In this regard, for example, the external aviation stabilization device 140 may be located in a remote cloud server and electronically and/or communicatively coupled to the aircraft 110, the onboard aviation stabilization device 180, the one or more aircraft components 130, and/or the one or more databases 170 via at least the network 150. In some embodiments, the external aviation stabilization device 140 is configured via hardware, software, firmware, and/or a combination thereof, to perform data intake of one or more types of data, such as aviation operations data, aviation operations display data, aviation operations impact data, predicted aviation operations impact data, aviation stability adjustment data, and/or the like.

Additionally, or alternatively, in some embodiments, the external aviation stabilization device 140 is configured via hardware, software, firmware, and/or a combination thereof, to generate and/or transmit command(s) that control, adjust, or otherwise impact operations of one or more of the aircraft 110, the onboard aviation stabilization device 180, the one or more aircraft components 130, and/or the one or more databases 170. For example, the external aviation stabilization device 140 may be configured to generate a stabilized aviation operations interface component. Additionally, or alternatively, in some embodiments, the external aviation stabilization device 140 is configured via hardware, software, firmware, and/or a combination thereof, to perform data reporting, provide data, and/or other data output process(es) associated with monitoring or otherwise analyzing operations of one or more of the aircraft 110, the onboard aviation stabilization device 180, the one or more aircraft components 130, and/or the one or more databases 170. For example, in various embodiments, the external aviation stabilization device 140 may be configured to execute and/or perform one or more operations and/or functions described herein.

In some embodiments, the environment 100 includes the onboard aviation stabilization device 180. In some embodiments, the onboard aviation stabilization device 180 is electronically and/or communicatively coupled to the aircraft 110, the external aviation stabilization device 140, the one or more aircraft components 130, and/or the one or more databases 170. The onboard aviation stabilization device 180 may be located within the aircraft 110. In some embodiments, the onboard aviation stabilization device 180 is a flight management system (FMS). For example, the onboard aviation stabilization device 180 may be a connected flight management system (CFMS). Additionally, or alternatively, the onboard aviation stabilization device 180 is an electronic flight bag (EFB). In some embodiments, the onboard aviation stabilization device 180 is physically secured to the aircraft 110. For example, the onboard aviation stabilization device 180 may be a built-in component of the aircraft 110 that is permanently secured to the aircraft 110 (e.g., when the onboard aviation stabilization device 180 is a flight management system (FMS)). As another example, the onboard aviation stabilization device 180 may not be a built-in component of the aircraft 110 that is temporarily secured to the aircraft 110 (e.g., when the onboard aviation stabilization device 180 is an electronic flight bag). In some embodiments, the onboard aviation stabilization device 180 is configured via hardware, software, firmware, and/or a combination thereof, to perform data intake of one or more types of data, such as aviation operations data, aviation operations display data, aviation operations impact data, predicted aviation operations impact data, aviation stability adjustment data, and/or the like.

Additionally, or alternatively, in some embodiments, the onboard aviation stabilization device 180 is configured via hardware, software, firmware, and/or a combination thereof, to generate and/or transmit command(s) that control, adjust, or otherwise impact operations of one or more of the aircraft 110, the external aviation stabilization device 140, the one or more aircraft components 130, and/or the one or more databases 170. For example, the onboard aviation stabilization device 180 may be configured to generate a stabilized aviation operations interface component. Additionally, or alternatively, in some embodiments, the onboard aviation stabilization device 180 is configured via hardware, software, firmware, and/or a combination thereof, to perform data reporting, provide data, and/or other data output process(es) associated with monitoring or otherwise analyzing operations of one or more of the aircraft 110, the external aviation stabilization device 140, the one or more aircraft components 130, and/or the one or more databases 170. For example, in various embodiments, the onboard aviation stabilization device 180 may be configured to execute and/or perform one or more operations and/or functions described herein. In some embodiments, the environment 100 includes the one or more aircraft components 130. In some embodiments, the one or more aircraft components 130 are electronically and/or communicatively coupled to the aircraft 110, the external aviation stabilization device 140, the onboard aviation stabilization device 180, and/or the one or more databases 170. The one or more aircraft components 130 may be located within the aircraft 110. In this regard, for example may be one or more individual components of the aircraft 110 that perform a particular function during operation of the aircraft 110. For example, the one or more aircraft components 130 may include one or more of multi-function control and display units (MCDU), flight management systems (FMS) (e.g., a secondary flight management system when the onboard aviation stabilization device 180 is a flight management system), inertial reference systems (IRS), global positioning systems (GPS), sensors, actuators, primary flight displays, radars (e.g., weather radars, millimeter wave-based radars, etc.), engines, auxiliary power units (APU), enhanced ground proximity warning systems (EGPWS), landing gear, flaps, power stations, ailerons, autopilot systems, empennages, cameras (cockpit cameras), inertial measurement units (IMU), gyroscopes, accelerometers, super buffers, display processors, LRUs, and/or the like. In this regard, for example, the individual components of the aircraft 110 may include components associated with a particular process or operation performed by the aircraft 110. In some embodiments, the one or more aircraft components 130 are physically secured to the aircraft 110. In some embodiments, the one or more aircraft components 130 include the onboard aviation stabilization device 180. In some embodiments, the one or more aircraft components 130 are configured via hardware, software, firmware, and/or a combination thereof, to perform data intake of one or more types of data, such as aviation operations data, aviation operations display data, aviation operations impact data, predicted aviation operations impact data, aviation stability adjustment data, and/or the like.

Additionally, or alternatively, in some embodiments, the one or more aircraft components 130 are configured via hardware, software, firmware, and/or a combination thereof, to generate and/or transmit command(s) that control, adjust, or otherwise impact operations of one or more of the aircraft 110, the external aviation stabilization device 140, the onboard aviation stabilization device 180, and/or the one or more databases 170. For example, the one or more aircraft components 130 may be configured to determine aviation mission impacts. Additionally, or alternatively, in some embodiments, the one or more aircraft components 130 are configured via hardware, software, firmware, and/or a combination thereof, to perform data reporting, provide data, and/or other data output process(es) associated with monitoring or otherwise analyzing operations of one or more of the aircraft 110, the external aviation stabilization device 140, the onboard aviation stabilization device 180, and/or the one or more databases 170. For example, in various embodiments, the one or more aircraft components 130 may be configured to execute and/or perform one or more operations and/or functions described herein.

In some embodiments, the onboard aviation stabilization device 180 and/or the external aviation stabilization device 140 is configured to cause actuation of one or more of the one or more aircraft components 130. For example, the onboard aviation stabilization device 180 and/or the external aviation stabilization device 140 may be configured to cause actuation of one or more of the one or more aircraft components 130 based on aviation operations data, aviation operations display data, aviation operations impact data, predicted aviation operations impact data, aviation stability adjustment data, and/or the like.

In some embodiments, the environment 100 includes one or more databases 170. The one or more databases 170 may be configured to receive, store, and/or transmit data. For example, the one or more databases 170 may be configured to receive, store, and/or transmit data associated with the aircraft 110, the external aviation stabilization device 140, the one or more aircraft components 130, and/or the onboard aviation stabilization device 180. In this regard, for example, the one or more databases 170 may be configured to receive, store, and/or transmit aviation operations data, aviation operations display data, aviation operations impact data, predicted aviation operations impact data, aviation stability adjustment data, and/or the like. The one or more databases 170 may be located remotely from the aircraft 110, in proximity of the aircraft 110, and/or within the aircraft 110.

The network 150 may be embodied in any of a myriad of network configurations. In some embodiments, the network 150 may be a public network (e.g., the Internet). In some embodiments, the network 150 may be a private network (e.g., an internal localized, or closed-off network between particular devices). In some other embodiments, the network 150 may be a hybrid network (e.g., a network enabling internal communications between particular connected devices and external communications with other devices). In various embodiments, the network 150 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 150. Such configuration(s) include, without limitation, a wired or wireless Personal Area Network (PAN), Local Area Network (LAN), Metropolitan Area Network (MAN), Wide Area Network (WAN), and/or the like.

Additionally, while FIG. 1 illustrates certain components as separate, standalone entities communicating over the network 150, various embodiments are not limited to this configuration. In other embodiments, one or more components may be directly connected and/or share hardware or the like. For example, in some embodiments, the external aviation stabilization device 140 may include the one or more databases 170.

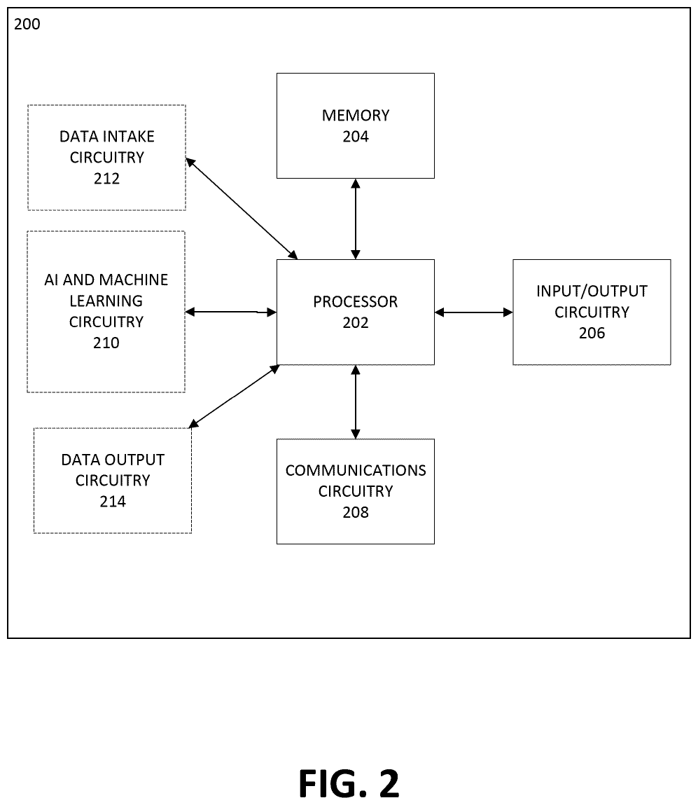

FIG. 2 illustrates an example block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, the external aviation stabilization device 140, the one or more aircraft components 130, the one or more databases 170, and/or the onboard aviation stabilization device 180. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory (ies), circuitry (ies), and/or the like to perform their associated functions such that duplicate hardware is not required for each set of circuitry.

In various embodiments, such as computing apparatus 200 of the external aviation stabilization device 140, the one or more aircraft components 130, the one or more databases 170, and/or the onboard aviation stabilization device 180 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the aircraft 110. In some embodiments, the data intake circuitry 212 includes hardware, software, firmware, and/or a combination thereof, that communicates with one or more sensor(s) component(s), and/or the like within the aircraft 110 to receive particular data associated with such operations of the aircraft 110. Additionally, or alternatively, in some embodiments, the data intake circuitry 212 includes hardware, software, firmware, and/or a combination thereof, that retrieves particular data associated with the aircraft 110 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

In some embodiments, the external aviation stabilization device 140 and/or the onboard aviation stabilization device 180 is configured to identify aviation operations data. In some embodiments, aviation operations data includes one or more items of data representative and/or indicative of one or more aircraft operations items. In some embodiments, an aviation operations item is an item associated with an aviation mission (e.g., an aviation mission being performed by the aircraft 110). In this regard, in some embodiments, an aviation operation item is a flight plan item. For example, a flight plan item may be representative of a flight plan that the aircraft 110 will follow to perform an aviation mission. In some embodiments, an aviation operation item is an altitude item. For example, an altitude item may be representative of one or more altitudes the aircraft 110 will operate at to perform an aviation mission. In some embodiments, an aviation operation item is a speed item. For example, a speed item may be representative of one or more speeds the aircraft 110 will operate at to perform an aviation mission.

In some embodiments, an aviation operation item is a heading item. For example, a heading item may be representative of one or more headings the aircraft 110 will follow to perform an aviation mission. In some embodiments, an aviation operation item is a distance to go item. For example, a distance to go item may be representative of a distance that the aircraft 110 still needs to travel to perform an aviation mission. In some embodiments, an aviation operation item is a time of arrival item. For example, a time of arrival item may be representative of a time at which the aircraft 110 will arrive at a destination airport. In some embodiments, an aviation operation item is a fuel expenditure item. For example, a fuel expenditure item may be representative of an amount of fuel that the aircraft 110 has used while performing an aviation mission. In some embodiments, an aviation operation item is an originating airport item. For example, an originating airport item may be representative of an airport at which the aircraft 110 is originating from in an aviation mission.

In some embodiments, an aviation operation item is a destination airport item. For example, a destination airport item may be representative of an airport at which the aircraft 110 is travelling to in an aviation mission. In some embodiments, an aviation operation item is a landing runway item. For example, a landing runway item may be representative of a runway at which the aircraft 110 will land at in an aviation mission. In some embodiments, an aviation operation item is a takeoff runway item. For example, a takeoff runway item may be representative of a runway at which the aircraft 110 will take off from in an aviation mission. In some embodiments, an aviation operation item is a taxiing item. For example, a taxiing item may be representative of a taxiing route that will be used by the aircraft 110 to taxi in an aviation mission. In some embodiments, an aviation operation item is an aircraft type item. For example, an aircraft type item may be representative of the aircraft type of the aircraft 110.

In some embodiments, identifying aviation operations data includes the external aviation stabilization device 140 and/or the onboard aviation stabilization device 180 being configured to receive aviation operations data. For example, the external aviation stabilization device 140 and/or the onboard aviation stabilization device 180 may be configured to receive aviation operations data from an operator of the aircraft 110 (e.g., the pilot). As another example, the external aviation stabilization device 140 and/or the onboard aviation stabilization device 180 may be configured to receive aviation operations data from the one or more databases 170. In some embodiments, identifying aviation operations data includes the external aviation stabilization device 140 and/or the onboard aviation stabilization device 180 being configured to generate aviation operations data. For example, the external aviation stabilization device 140 and/or the onboard aviation stabilization device 180 may be configured to generate aviation operations data using the one or more aircraft components 130.

In some embodiments, the external aviation stabilization device 140 and/or the onboard aviation stabilization device 180 is configured to generate an aviation operations interface component 300. In some embodiments, the aviation operations interface component 300 is generated based on aviation operations data. In this regard, in some embodiments, the aviation operations interface component 300 includes one or more aviation operations display items 304 that are configured to display one or more aviation operations items. For example, the aviation operations interface component 300 may include one or more aviation operations display items 304 that include a flight plan display item, an altitude display item, a speed display item, a heading display item, a distance to go display item, a time of arrival display item, a fuel expenditure display item, an originating airport display item, a destination airport display item, a landing runway display item, a takeoff runway display item, a taxiing display item, an aircraft type display item, and/or the like. In some embodiments, each of the one or more aviation operations display items 304 is associated with an original display item position on the aviation operations interface component 300. In this regard, for example, an original display item position may be a position on the aviation operations interface component 300 at which an aviation operations display item is displayed and/or located on the aviation operations interface component 300.

In some embodiments, the aviation operations interface component 300 includes one or more touch zones 306. In some embodiments, the one or more touch zones 306 are selectable portions of the aviation operations interface component 300. For example, the one or more touch zones 306 may be selectable to display information about an aviation operations display item of the one or more aviation operations display items 304. Additionally, or alternatively, the one or more touch zones 306 may be configured to control the aircraft 110 and/or the one or more aircraft components 130 of the aircraft 110.

In some embodiments, the one or more touch zones 306 are associated with an original touch zone position on the aviation operations interface component 300. In this regard, for example, an original touch zone position may be a position on the aviation operations interface component 300 at which a touch zone in the one or more touch zones 306 is displayed and/or located on the aviation operations interface component 300 (e.g., touching an original touch zone position may select a touch zone).

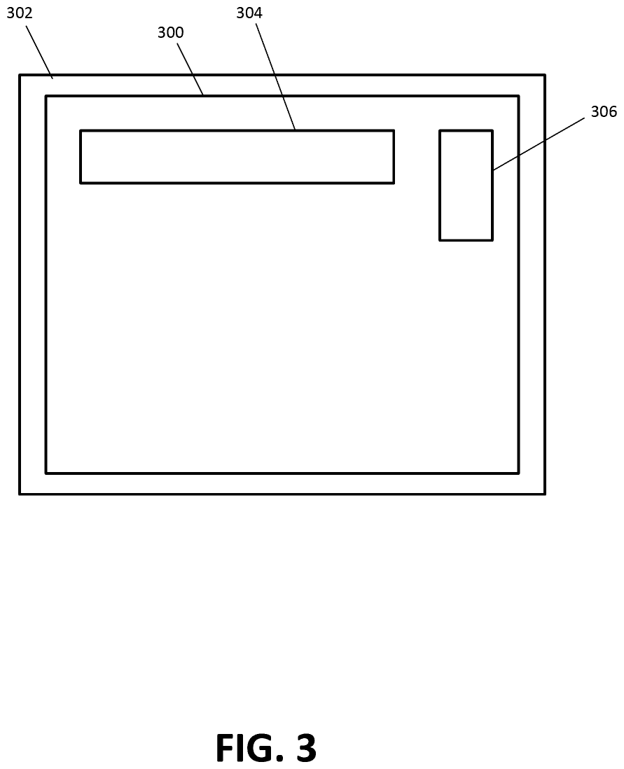

In some embodiments, the external aviation stabilization device 140 and/or the onboard aviation stabilization device 180 is configured to cause the aviation operations interface component 300 to be rendered to an aviation operations interface 302, such as illustrated in FIG. 3. In some embodiments, the aviation operations interface 302 is provided on the onboard aviation stabilization device 180 and/or one or more of the one or more aircraft components 130. For example, the aviation operations interface 302 may be provided on a multi-function control and display unit. In this regard, for example, the aviation operations interface 302 may be provided to an operator of the aircraft 110 (e.g., a pilot) while the aircraft 110 is performing an aviation mission.

In some embodiments, the external aviation stabilization device 140 and/or the onboard aviation stabilization device 180 is configured to receive aviation operations display data. In some embodiments, aviation operations display data includes one or more items of data representative and/or indicative of the aviation operations interface component 300. In this regard, in some embodiments, aviation operations display data includes one or more items of data representative of the one or more aviation operations display items 304. Additionally, or alternatively, aviation operations display data includes one or more items of data representative of the one or more touch zones 306.

In some embodiments, the external aviation stabilization device 140 and/or the onboard aviation stabilization device 180 is configured to capture aviation operations impact data. In some embodiments, aviation operations impact data includes one or more items of data representative and/or indicative of an aviation instability event. In this regard, in some embodiments, an aviation instability event is an event that causes acceleration motion (e.g., motion in an X, Y, and/or Z axis) and/or angular motion (e.g., azimuth, elevation, and/or roll motion) of the aircraft 110. Additionally, or alternatively, an aviation instability event is an event that causes acceleration motion (e.g., motion in an X, Y, and/or Z axis) and/or angular motion (e.g., azimuth, elevation, and/or roll motion) of the onboard aviation stabilization device 180 and/or one or more of the one or more aircraft components 130 (e.g., an aircraft component on which the aviation operations interface 302 is provided). Additionally, or alternatively, an aviation instability event is an event that causes acceleration motion (e.g., motion in an X, Y, and/or Z axis) and/or angular motion (e.g., azimuth, elevation, and/or roll motion) of the eyes of an operator of the aircraft 110 (e.g., eyes of a pilot).

In some embodiments, an aviation instability event is a takeoff associated with the aircraft 110. In this regard, for example, a takeoff associated with the aircraft 110 may cause acceleration motion (e.g., motion in an X, Y, and/or Z axis) and/or angular motion (e.g., azimuth, elevation, and/or roll motion) of the aircraft 110, the onboard aviation stabilization device 180, one or more of the one or more aircraft components 130, and/or the eyes of an operator of the aircraft 110. In some embodiments, an aviation instability event is a landing associated with the aircraft 110. In this regard, for example, a landing associated with the aircraft 110 may cause acceleration motion (e.g., motion in an X, Y, and/or Z axis) and/or angular motion (e.g., azimuth, elevation, and/or roll motion) of the aircraft 110, the onboard aviation stabilization device 180, one or more of the one or more aircraft components 130, and/or the eyes of an operator of the aircraft 110. In some embodiments, an aviation instability event is weather associated with the aircraft 110. In this regard, for example, weather associated with the aircraft 110 may cause acceleration motion (e.g., motion in an X, Y, and/or Z axis) and/or angular motion (e.g., azimuth, elevation, and/or roll motion) of the aircraft 110, the onboard aviation stabilization device 180, one or more of the one or more aircraft components 130, and/or the eyes of an operator of the aircraft 110. In some embodiments, an aviation instability event is turbulence associated with the aircraft 110. In this regard, for example, turbulence associated with the aircraft 110 may cause acceleration motion (e.g., motion in an X, Y, and/or Z axis) and/or angular motion (e.g., azimuth, elevation, and/or roll motion) of the aircraft 110, the onboard aviation stabilization device 180, one or more of the one or more aircraft components 130, and/or the eyes of an operator of the aircraft 110.

In some embodiments, the external aviation stabilization device 140 and/or the onboard aviation stabilization device 180 is configured to capture aviation operations impact data using one or more of the one or more aircraft components 130. For example, the external aviation stabilization device 140 and/or the onboard aviation stabilization device 180 may be configured to capture aviation operations impact data using one or more cockpit cameras, inertial measuring units, motion sensors, gyroscopes, accelerometers, and/or the like. Additionally, or alternatively, the external aviation stabilization device 140 and/or the onboard aviation stabilization device 180 is configured to capture aviation operations impact data using the onboard aviation stabilization device 180. For example, the external aviation stabilization device 140 and/or the onboard aviation stabilization device 180 may be configured to capture aviation operations impact data using an inertial measuring unit associated with the onboard aviation stabilization device 180.

In some embodiments, the external aviation stabilization device 140 and/or the onboard aviation stabilization device 180 is configured to generate aviation stability adjustment data. In some embodiments, aviation stability adjustment data includes one or more items of data representative and/or indicative of an estimated position change of an eye gaze of an operator (e.g., a pilot) of the aircraft 110 due to an aviation instability event. Additionally, or alternatively, aviation stability adjustment data includes one or more items of data representative and/or indicative of an estimated position change of the onboard aviation stabilization device 180 and/or one or more of the one or more aircraft components 130 due to an aviation instability event.

In some embodiments, the external aviation stabilization device 140 and/or the onboard aviation stabilization device 180 is configured to generate aviation stability adjustment data by applying aviation operations impact data to an aviation stability adjustment model. In some embodiments, an aviation stability adjustment model is a data entity that describes parameters, hyper-parameters, and/or defined operations of a rules-based and/or machine learning model that is configured to generate aviation stability adjustment data. In this regard, in some embodiments, the aviation stability adjustment model is configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, generative artificial intelligence techniques, filtration techniques, grouping techniques, sorting techniques, trend techniques, correlation techniques, anomaly detection techniques, clustering techniques, and/or the like. In this regard, in some embodiments, the aviation stability adjustment model is configured to determine an estimated position change of an eye gaze of an operator (e.g., a pilot) of the aircraft 110 due to an aviation instability event by using aviation operations impact data. Additionally, or alternatively, the aviation stability adjustment model is configured to determine an estimated position change of the onboard aviation stabilization device 180 and/or one or more of the one or more aircraft components 130 due to an aviation instability event using aviation operations impact data.

In some embodiments, the external aviation stabilization device 140 and/or the onboard aviation stabilization device 180 is configured to generate a stabilized aviation operations interface component 400. In some embodiments, the stabilized aviation operations interface component 400 is configured to be generated based on aviation stability adjustment data and/or aviation operations display data. In this regard, in some embodiments, the stabilized aviation operations interface component 400, includes one or more stabilized aviation operations display items 404 that correspond to the aviation operations display items 304. For example, the stabilized aviation operations interface component 400 may include one or more stabilized aviation operations display items 404 that include a flight plan display item, an altitude item, a speed display item, a heading display item, a distance to go display item, a time of arrival display item, a fuel expenditure display item, an originating airport display item, a destination airport display item, a landing runway display item, a takeoff runway display item, a taxiing display item, an aircraft type display item, and/or the like.

In some embodiments, each of the one or more stabilized aviation operations display items 404 is associated with a stabilized display item position on the stabilized aviation operations interface component 400. In this regard, for example, a stabilized display item position may be a position on the stabilized aviation operations interface component 400 at which a stabilized aviation operations display item is displayed and/or located on the stabilized aviation operations interface component 400. In some embodiments, a stabilized display item position may be a different position that an original display item position. Said differently, in some embodiments, the stabilized aviation operations interface component 400 is configured such that an estimated position change of an eye gaze of an operator (e.g., a pilot) of the aircraft 110 and/or an estimated position change of the onboard aviation stabilization device 180 and/or one or more of the one or more aircraft components 130 due to an aviation instability event is accounted for when displaying display items associated with aircraft operations items.

In some embodiments, the stabilized aviation operations interface component 400 includes one or more remapped touch zones 406. In some embodiments, the one or more remapped touch zones 406 are selectable portions of the stabilized aviation operations interface component 400. For example, the one or more remapped touch zones 406 may be selectable to display information about a stabilized aviation operations display item of the one or more stabilized aviation operations display items 404.

In some embodiments, the one or more remapped touch zones 406 are associated with a remapped touch zone position on the stabilized aviation operations interface component 400. In this regard, for example, a remapped touch zone position may be a position on the stabilized aviation operations interface component 400 at which a remapped touch zone in the one or more remapped touch zones 406 is displayed and/or located on the stabilized aviation operations interface component 400 (e.g., touching a remapped touch zone position may select a remapped touch zone). Said differently, for example, the one or more remapped touch zones 406 may corresponded to the one or more touch zones 306 but located at a different position to account for an aviation instability event.

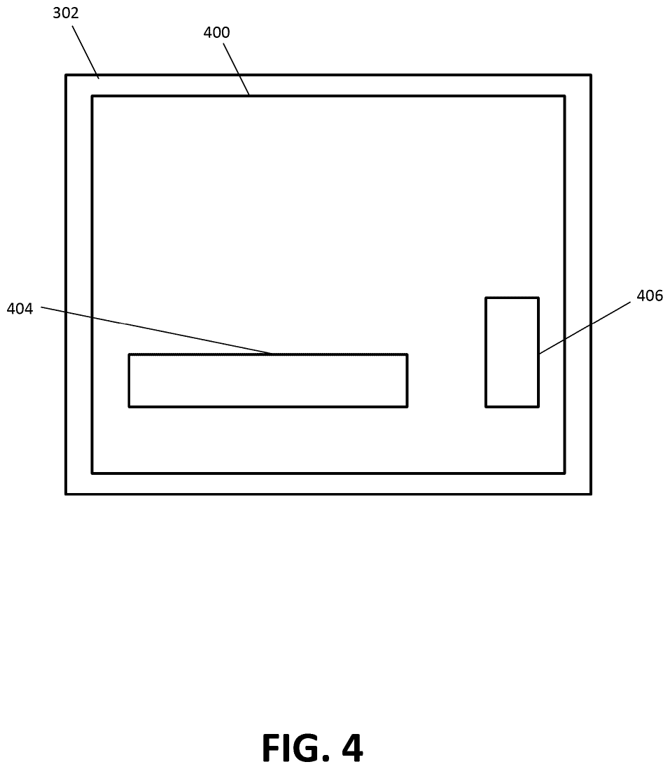

In some embodiments, the external aviation stabilization device 140 and/or the onboard aviation stabilization device 180 is configured to cause the stabilized aviation operations interface component 400 to be rendered to an aviation operations interface 302, such as illustrated in FIG. 4. In some embodiments, the stabilized aviation operations interface component 400 is provided on the onboard aviation stabilization device 180 and/or one or more of the one or more aircraft components 130. For example, the stabilized aviation operations interface component 400 may be provided on a multi-function control and display unit. In this regard, for example, the stabilized aviation operations interface component 400 may be provided to an operator of the aircraft 110 (e.g., a pilot) while the aircraft 110 is performing an aviation mission.

In some embodiments, the external aviation stabilization device 140 and/or the onboard aviation stabilization device 180 is configured to identify predicted aviation operations impact data. In some embodiments, predicted aviation operations impact data includes one or more items of data representative and/or indicative of a predicted aviation instability event. In this regard, in some embodiments, a predicted aviation instability event is a predicted event that is predicted to cause acceleration motion (e.g., motion in an X, Y, and/or Z axis) and/or angular motion (e.g., azimuth, elevation, and/or roll motion) of the aircraft 110. Additionally, or alternatively, a predicted aviation instability event is a predicted event that is predicted to cause acceleration motion (e.g., motion in an X, Y, and/or Z axis) and/or angular motion (e.g., azimuth, elevation, and/or roll motion) of the onboard aviation stabilization device 180 and/or one or more of the one or more aircraft components 130 (e.g., an aircraft component on which the aviation operations interface 302 is provided). Additionally, or alternatively, a predicted aviation instability event is a predicted event that is predicted to cause acceleration motion (e.g., motion in an X, Y, and/or Z axis) and/or angular motion (e.g., azimuth, elevation, and/or roll motion) of the eyes of an operator of the aircraft 110 (e.g., eyes of a pilot).

In some embodiments, a predicted aviation instability event is a predicted takeoff associated with the aircraft 110. In this regard, for example, a predicted takeoff associated with the aircraft 110 may be predicted to cause acceleration motion (e.g., motion in an X, Y, and/or Z axis) and/or angular motion (e.g., azimuth, elevation, and/or roll motion) of the aircraft 110, the onboard aviation stabilization device 180, one or more of the one or more aircraft components 130, and/or the eyes of an operator of the aircraft 110. In some embodiments, a predicted aviation instability event is a predicted landing associated with the aircraft 110. In this regard, for example, a predicted landing associated with the aircraft 110 may be predicted to cause acceleration motion (e.g., motion in an X, Y, and/or Z axis) and/or angular motion (e.g., azimuth, elevation, and/or roll motion) of the aircraft 110, the onboard aviation stabilization device 180, one or more of the one or more aircraft components 130, and/or the eyes of an operator of the aircraft 110. In some embodiments, a predicted aviation instability event is predicted weather associated with the aircraft 110. In this regard, for example, predicted weather associated with the aircraft 110 may me predicted to cause acceleration motion (e.g., motion in an X, Y, and/or Z axis) and/or angular motion (e.g., azimuth, elevation, and/or roll motion) of the aircraft 110, the onboard aviation stabilization device 180, one or more of the one or more aircraft components 130, and/or the eyes of an operator of the aircraft 110. In some embodiments, a predicted aviation instability event is predicted turbulence associated with the aircraft 110. In this regard, for example, predicted turbulence associated with the aircraft 110 may be predicted to cause acceleration motion (e.g., motion in an X, Y, and/or Z axis) and/or angular motion (e.g., azimuth, elevation, and/or roll motion) of the aircraft 110, the onboard aviation stabilization device 180, one or more of the one or more aircraft components 130, and/or the eyes of an operator of the aircraft 110.

In some embodiments, the external aviation stabilization device 140 and/or the onboard aviation stabilization device 180 is configured to determine that the aircraft 110 is predicted to be impacted by an aviation instability event based on predicted aviation operations impact data. In this regard, in some embodiments, the external aviation stabilization device 140 and/or the onboard aviation stabilization device 180 is configured to preemptively generate aviation stability adjustment data such that the stabilized aviation operations interface component 400 can be rendered as soon as the aircraft 110 is impacted by an aviation instability event. In this way, for example, the external aviation stabilization device 140 and/or the onboard aviation stabilization device 180 may be able to provide stabilized interface components (e.g., the stabilized aviation operations interface component 400) to an operator of the aircraft 110 in a seamless manner.

### Example Methods

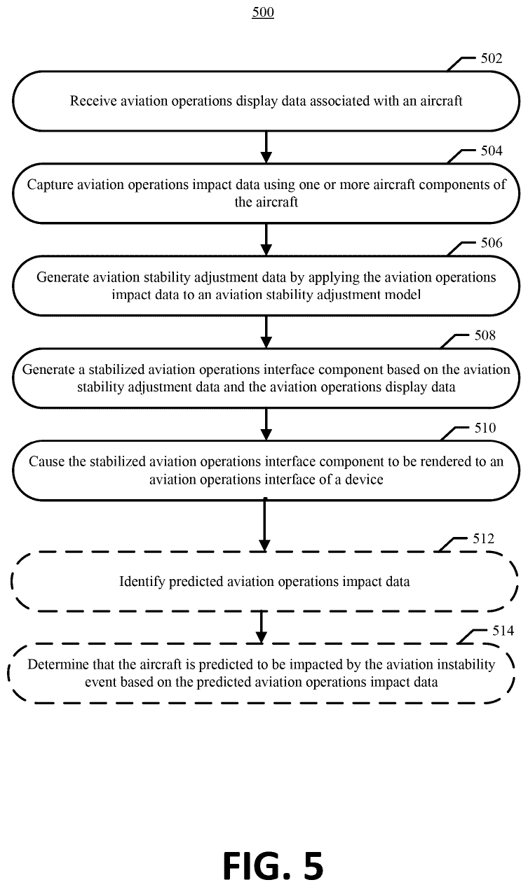

Referring now to FIG. 5, a flowchart providing an example method 500 is illustrated. In this regard, FIG. 5 illustrates operations that may be performed by the external aviation stabilization device 140, the aircraft 110, the one or more databases 170, the one or more aircraft components 130, and/or the onboard aviation stabilization device 180. In some embodiments, the method 500 includes operations for generating a stabilized aviation operations interface component and/or causing the stabilized aviation operations interface component to be rendered to an aviation operations interface, as described above. In some embodiments, the example method 500 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500.

As shown in block 502, the method 500 includes aviation operations display data associated with an aircraft. As described above, in some embodiments, aviation operations display data includes one or more items of data representative and/or indicative of the aviation operations interface component. In this regard, in some embodiments, aviation operations display data includes one or more items of data representative of the one or more aviation operations display items. Additionally, or alternatively, aviation operations display data includes one or more items of data representative of the one or more touch zones.

As shown in block 504, the method 500 includes capturing aviation operations impact data using one or more aircraft components of the aircraft. As described above, in some embodiments, aviation operations impact data includes one or more items of data representative and/or indicative of an aviation instability event. In this regard, in some embodiments, an aviation instability event is an event that causes acceleration motion (e.g., motion in an X, Y, and/or Z axis) and/or angular motion (e.g., azimuth, elevation, and/or roll motion) of the aircraft. Additionally, or alternatively, an aviation instability event is an event that causes acceleration motion (e.g., motion in an X, Y, and/or Z axis) and/or angular motion (e.g., azimuth, elevation, and/or roll motion) of the onboard aviation stabilization device and/or one or more of the one or more aircraft components (e.g., an aircraft component on which the aviation operations interface is provided). Additionally, or alternatively, an aviation instability event is an event that causes acceleration motion (e.g., motion in an X, Y, and/or Z axis) and/or angular motion (e.g., azimuth, elevation, and/or roll motion) of the eyes of an operator of the aircraft (e.g., eyes of a pilot).

In some embodiments, an aviation instability event is a takeoff associated with the aircraft. In this regard, for example, a takeoff associated with the aircraft may cause acceleration motion (e.g., motion in an X, Y, and/or Z axis) and/or angular motion (e.g., azimuth, elevation, and/or roll motion) of the aircraft, the onboard aviation stabilization device, one or more of the one or more aircraft components, and/or the eyes of an operator of the aircraft. In some embodiments, an aviation instability event is a landing associated with the aircraft. In this regard, for example, a landing associated with the aircraft may cause acceleration motion (e.g., motion in an X, Y, and/or Z axis) and/or angular motion (e.g., azimuth, elevation, and/or roll motion) of the aircraft, the onboard aviation stabilization device, one or more of the one or more aircraft components, and/or the eyes of an operator of the aircraft. In some embodiments, an aviation instability event is weather associated with the aircraft. In this regard, for example, weather associated with the aircraft may cause acceleration motion (e.g., motion in an X, Y, and/or Z axis) and/or angular motion (e.g., azimuth, elevation, and/or roll motion) of the aircraft, the onboard aviation stabilization device, one or more of the one or more aircraft components, and/or the eyes of an operator of the aircraft. In some embodiments, an aviation instability event is turbulence associated with the aircraft. In this regard, for example, turbulence associated with the aircraft may cause acceleration motion (e.g., motion in an X, Y, and/or Z axis) and/or angular motion (e.g., azimuth, elevation, and/or roll motion) of the aircraft, the onboard aviation stabilization device, one or more of the one or more aircraft components, and/or the eyes of an operator of the aircraft.

In some embodiments, the external aviation stabilization device and/or the onboard aviation stabilization device is configured to capture aviation operations impact data using one or more of the one or more aircraft components. For example, the external aviation stabilization device and/or the onboard aviation stabilization device may be configured to capture aviation operations impact data using one or more cockpit cameras, inertial measuring units, motion sensors, gyroscopes, accelerometers, and/or the like. Additionally, or alternatively, the external aviation stabilization device and/or the onboard aviation stabilization device is configured to capture aviation operations impact data using the onboard aviation stabilization device. For example, the external aviation stabilization device and/or the onboard aviation stabilization device may be configured to capture aviation operations impact data using an inertial measuring unit associated with the onboard aviation stabilization device.

As shown in block 506, the method 500 includes generating aviation stability adjustment data by applying the aviation operations impact data to an aviation stability adjustment model. As described above, in some embodiments, aviation stability adjustment data includes one or more items of data representative and/or indicative of an estimated position change of an eye gaze of an operator (e.g., a pilot) of the aircraft due to an aviation instability event. Additionally, or alternatively, aviation stability adjustment data includes one or more items of data representative and/or indicative of an estimated position change of the onboard aviation stabilization device and/or one or more of the one or more aircraft components due to an aviation instability event.

In some embodiments, the external aviation stabilization device and/or the onboard aviation stabilization device is configured to generate aviation stability adjustment data by applying aviation operations impact data to an aviation stability adjustment model. In some embodiments, an aviation stability adjustment model is a data entity that describes parameters, hyper-parameters, and/or defined operations of a rules-based and/or machine learning model that is configured to generate aviation stability adjustment data. In this regard, in some embodiments, the aviation stability adjustment model is configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, generative artificial intelligence techniques, filtration techniques, grouping techniques, sorting techniques, trend techniques, correlation techniques, anomaly detection techniques, clustering techniques, and/or the like. In this regard, in some embodiments, the aviation stability adjustment model is configured to determine an estimated position change of an eye gaze of an operator (e.g., a pilot) of the aircraft due to an aviation instability event by using aviation operations impact data. Additionally, or alternatively, the aviation stability adjustment model is configured to determine an estimated position change of the onboard aviation stabilization device and/or one or more of the one or more aircraft components due to an aviation instability event using aviation operations impact data.

As shown in block 508, the method 500 includes generating a stabilized aviation operations interface component based on the aviation stability adjustment data and the aviation operations display data. As described above, in some embodiments, the stabilized aviation operations interface component, includes one or more stabilized aviation operations display items that correspond to the aviation operations display items. For example, the stabilized aviation operations interface component may include one or more stabilized aviation operations display items that include a flight plan display item, an altitude item, a speed display item, a heading display item, a distance to go display item, a time of arrival display item, a fuel expenditure display item, an originating airport display item, a destination airport display item, a landing runway display item, a takeoff runway display item, a taxiing display item, an aircraft type display item, and/or the like.

In some embodiments, each of the one or more stabilized aviation operations display items is associated with a stabilized display item position on the stabilized aviation operations interface component. In this regard, for example, a stabilized display item position may be a position on the stabilized aviation operations interface component at which a stabilized aviation operations display item is displayed and/or located on the stabilized aviation operations interface component. In some embodiments, a stabilized display item position may be a different position that an original display item position. Said differently, in some embodiments, the stabilized aviation operations interface component is configured such that an estimated position change of an eye gaze of an operator (e.g., a pilot) of the aircraft and/or an estimated position change of the onboard aviation stabilization device and/or one or more of the one or more aircraft components due to an aviation instability event is accounted for when displaying display items associated with aircraft operations items.

In some embodiments, the stabilized aviation operations interface component includes one or more remapped touch zones. In some embodiments, the one or more remapped touch zones are selectable portions of the stabilized aviation operations interface component. For example, the one or more remapped touch zones may be selectable to display information about a stabilized aviation operations display item of the one or more stabilized aviation operations display items. In some embodiments, the one or more remapped touch zones are associated with a remapped touch zone position on the stabilized aviation operations interface component. In this regard, for example, a remapped touch zone position may be a position on the stabilized aviation operations interface component at which a remapped touch zone in the one or more remapped touch zones is displayed and/or located on the stabilized aviation operations interface component (e.g., touching a remapped touch zone position may select a remapped touch zone). Said differently, for example, the one or more remapped touch zones may correspond to the one or more touch zones but located at a different position to account for an aviation instability event.

As shown in block 510, the method 500 includes causing the stabilized aviation operations interface component to be rendered to an aviation operations interface of a device. As described above, in some embodiments, the stabilized aviation operations interface component is provided on the onboard aviation stabilization device and/or one or more of the one or more aircraft components. For example, the stabilized aviation operations interface component may be provided on a multi-function control and display unit. In this regard, for example, the stabilized aviation operations interface component may be provided to an operator of the aircraft (e.g., a pilot) while the aircraft is performing an aviation mission.

As shown in optional block 512, the method 500 optionally includes identifying predicted aviation operations impact data. As described above, in some embodiments, predicted aviation operations impact data includes one or more items of data representative and/or indicative of a predicted aviation instability event. In this regard, in some embodiments, a predicted aviation instability event is a predicted event that is predicted to cause acceleration motion (e.g., motion in an X, Y, and/or Z axis) and/or angular motion (e.g., azimuth, elevation, and/or roll motion) of the aircraft. Additionally, or alternatively, a predicted aviation instability event is a predicted event that is predicted to cause acceleration motion (e.g., motion in an X, Y, and/or Z axis) and/or angular motion (e.g., azimuth, elevation, and/or roll motion) of the onboard aviation stabilization device and/or one or more of the one or more aircraft components (e.g., an aircraft component on which the aviation operations interface is provided). Additionally, or alternatively, a predicted aviation instability event is a predicted event that is predicted to cause acceleration motion (e.g., motion in an X, Y, and/or Z axis) and/or angular motion (e.g., azimuth, elevation, and/or roll motion) of the eyes of an operator of the aircraft (e.g., eyes of a pilot).

In some embodiments, a predicted aviation instability event is a predicted takeoff associated with the aircraft. In this regard, for example, a predicted takeoff associated with the aircraft may be predicted to cause acceleration motion (e.g., motion in an X, Y, and/or Z axis) and/or angular motion (e.g., azimuth, elevation, and/or roll motion) of the aircraft, the onboard aviation stabilization device, one or more of the one or more aircraft components, and/or the eyes of an operator of the aircraft. In some embodiments, a predicted aviation instability event is a predicted landing associated with the aircraft. In this regard, for example, a predicted landing associated with the aircraft may be predicted to cause acceleration motion (e.g., motion in an X, Y, and/or Z axis) and/or angular motion (e.g., azimuth, elevation, and/or roll motion) of the aircraft, the onboard aviation stabilization device, one or more of the one or more aircraft components, and/or the eyes of an operator of the aircraft. In some embodiments, a predicted aviation instability event is predicted weather associated with the aircraft. In this regard, for example, predicted weather associated with the aircraft may me predicted to cause acceleration motion (e.g., motion in an X, Y, and/or Z axis) and/or angular motion (e.g., azimuth, elevation, and/or roll motion) of the aircraft, the onboard aviation stabilization device, one or more of the one or more aircraft components, and/or the eyes of an operator of the aircraft. In some embodiments, a predicted aviation instability event is predicted turbulence associated with the aircraft. In this regard, for example, predicted turbulence associated with the aircraft may be predicted to cause acceleration motion (e.g., motion in an X, Y, and/or Z axis) and/or angular motion (e.g., azimuth, elevation, and/or roll motion) of the aircraft, the onboard aviation stabilization device, one or more of the one or more aircraft components, and/or the eyes of an operator of the aircraft.

As shown in optional block 514, the method 500 optionally includes determining that the aircraft is predicted to be impacted by the aviation instability event based on the predicted aviation operations impact data. As described above, in some embodiments, the external aviation stabilization device and/or the onboard aviation stabilization device is configured to preemptively generate aviation stability adjustment data such that the stabilized aviation operations interface component can be rendered as soon as the aircraft is impacted by an aviation instability event. In this way, for example, the external aviation stabilization device and/or the onboard aviation stabilization device may be able to provide stabilized interface components (e.g., the stabilized aviation operations interface component) to an operator of the aircraft in a seamless manner.

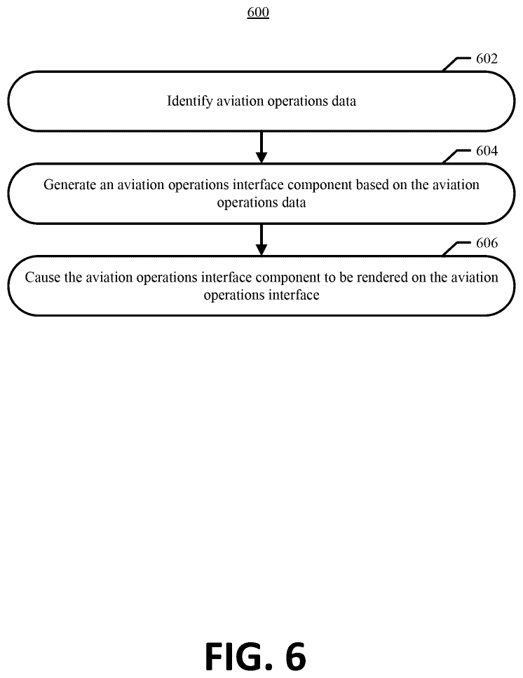

Referring now to FIG. 6, a flowchart providing an example method 600 is illustrated. In this regard, FIG. 6 illustrates operations that may be performed by the external aviation stabilization device 140, the aircraft 110, the one or more databases 170, the one or more aircraft components 130, and/or the onboard aviation stabilization device 180. In some embodiments, the method 600 includes operations for generating an aviation operations interface component and/or causing the aviation operations interface component to be rendered to an aviation operations interface, as described above. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As shown in block 602, the method 600 includes identifying aviation operations data. As described above, in some embodiments, aviation operations data includes one or more items of data representative and/or indicative of one or more aircraft operations items. In some embodiments, an aviation operations item is an item associated with an aviation mission (e.g., an aviation mission being performed by the aircraft). In this regard, in some embodiments, an aviation operation item is a flight plan item. For example, a flight plan item may be representative of a flight plan that the aircraft will follow to perform an aviation mission. In some embodiments, an aviation operation item is an altitude item. For example, an altitude item may be representative of one or more altitudes the aircraft will operate at to perform an aviation mission. In some embodiments, an aviation operation item is a speed item. For example, a speed item may be representative of one or more speeds the aircraft will operate at to perform an aviation mission.

In some embodiments, an aviation operation item is a heading item. For example, a heading item may be representative of one or more headings the aircraft will follow to perform an aviation mission. In some embodiments, an aviation operation item is a distance to go item. For example, a distance to go item may be representative of a distance that the aircraft still needs to travel to perform an aviation mission. In some embodiments, an aviation operation item is a time of arrival item. For example, a time of arrival item may be representative of a time at which the aircraft will arrive at a destination airport. In some embodiments, an aviation operation item is a fuel expenditure item. For example, a fuel expenditure item may be representative of an amount of fuel that the aircraft has used while performing an aviation mission. In some embodiments, an aviation operation item is an originating airport item. For example, an originating airport item may be representative of an airport at which the aircraft is originating from in an aviation mission.

In some embodiments, an aviation operation item is a destination airport item. For example, a destination airport item may be representative of an airport at which the aircraft is travelling to in an aviation mission. In some embodiments, an aviation operation item is a landing runway item. For example, a landing runway item may be representative of a runway at which the aircraft will land at in an aviation mission. In some embodiments, an aviation operation item is a takeoff runway item. For example, a takeoff runway item may be representative of a runway at which the aircraft will take off from in an aviation mission. In some embodiments, an aviation operation item is a taxiing item. For example, a taxiing item may be representative of a taxiing route that will be used by the aircraft to taxi in an aviation mission. In some embodiments, an aviation operation item is an aircraft type item. For example, an aircraft type item may be representative of the aircraft type of the aircraft.

In some embodiments, identifying aviation operations data includes the external aviation stabilization device and/or the onboard aviation stabilization device being configured to receive aviation operations data. For example, the external aviation stabilization device and/or the onboard aviation stabilization device may be configured to receive aviation operations data from an operator of the aircraft (e.g., the pilot). As another example, the external aviation stabilization device and/or the onboard aviation stabilization device may be configured to receive aviation operations data from the one or more databases. In some embodiments, identifying aviation operations data includes the external aviation stabilization device and/or the onboard aviation stabilization device being configured to generate aviation operations data. For example, the external aviation stabilization device and/or the onboard aviation stabilization device may be configured to generate aviation operations data using the one or more aircraft components.

As shown in block 604, the method 600 includes generating an aviation operations interface component based on the aviation operations data. As described above, in some embodiments, the aviation operations interface component includes one or more aviation operations display items that are configured to display one or more aviation operations items. For example, the aviation operations interface component may include one or more aviation operations display items that include a flight plan display item, an altitude display item, a speed display item, a heading display item, a distance to go display item, a time of arrival display item, a fuel expenditure display item, an originating airport display item, a destination airport display item, a landing runway display item, a takeoff runway display item, a taxiing display item, an aircraft type display item, and/or the like. In some embodiments, each of the one or more aviation operations display items is associated with an original display item position on the aviation operations interface component. In this regard, for example, an original display item position may be a position on the aviation operations interface component at which an aviation operations display item is displayed and/or located on the aviation operations interface component.

In some embodiments, the aviation operations interface component includes one or more touch zones. In some embodiments, the one or more touch zones are selectable portions of the aviation operations interface component. For example, the one or more touch zones may be selectable to display information about an aviation operations display item of the one or more aviation operations display items. Additionally, or alternatively, the one or more touch zones may be configured to control the aircraft and/or the one or more components of the aircraft.

In some embodiments, the one or more touch zones are associated with an original touch zone position on the aviation operations interface component. In this regard, for example, an original touch zone position may be a position on the aviation operations interface component at which a touch zone in the one or more touch zones is displayed and/or located on the aviation operations interface component (e.g., touching an original touch zone position may select a touch zone).

As shown in block 606, the method 600 includes causing the aviation operations interface component to be rendered on the aviation operations interface. As described above, in some embodiments, the aviation operations interface is provided on the onboard aviation stabilization device and/or one or more of the one or more aircraft components. For example, the aviation operations interface may be provided on a multi-function control and display unit. In this regard, for example, the aviation operations interface may be provided to an operator of the aircraft (e.g., a pilot) while the aircraft is performing an aviation mission.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
receiving aviation operations display data associated with an aircraft;
capturing aviation operations impact data using one or more aircraft components of the aircraft, wherein the aviation operations impact data is indicative of an aviation instability event;
generating aviation stability adjustment data by applying the aviation operations impact data to an aviation stability adjustment model;
generating a stabilized aviation operations interface component based on the aviation stability adjustment data and the aviation operations display data, wherein the stabilized aviation operations interface component comprises one or more stabilized aviation operations display items; and
causing the stabilized aviation operations interface component to be rendered to an aviation operations interface of a device.

2. The method of claim 1, wherein the aviation operations interface comprises one or more touch zones.

3. The method of claim 1, wherein the stabilized aviation operations interface component comprises one or more remapped touch zones.

4. The method of claim 1, further comprising:
identifying predicted aviation operations impact data; and
determining that the aircraft is predicted to be impacted by the aviation instability event based on the predicted aviation operations impact data.

5. The method of claim 1, further comprising:
identifying aviation operations data;
generating an aviation operations interface component based on the aviation operations data, wherein the aviation operations interface component comprises one or more aviation operations display items; and
causing the aviation operations interface component to be rendered on the aviation operations interface.

6. The method of claim 1, wherein the aviation instability event is one or more of a landing associated with the aircraft, a takeoff associated with the aircraft, weather associated with the aircraft, or turbulence associated with the aircraft.

7. The method of claim 1, wherein the aviation operations impact data is captured when the aircraft is performing an aviation mission.

8. The method of claim 1, wherein the device is a flight management system, an electronic flight bag, or a multi-function control and display unit.

9. The method of claim 1, wherein the device is physically secured to the aircraft.

10. The method of claim 1, wherein the aviation stability adjustment data is representative of an estimated position change of an eye gaze of an operator of the aircraft.

11. The method of claim 1, wherein the aviation stability adjustment data is representative of an estimated position change of the device.

12. An apparatus comprising memory and one or more processors communicatively coupled to the memory, the one or more processors configured to:
receive aviation operations display data associated with an aircraft;
capture aviation operations impact data using one or more aircraft components of the aircraft, wherein the aviation operations impact data is indicative of an aviation instability event;
generate aviation stability adjustment data by applying the aviation operations impact data to an aviation stability adjustment model;
generate a stabilized aviation operations interface component based on the aviation stability adjustment data and the aviation operations display data, wherein the stabilized aviation operations interface component comprises one or more stabilized aviation operations display items; and
cause the stabilized aviation operations interface component to be rendered to an aviation operations interface of a device.

13. The apparatus of claim 12, wherein the aviation operations interface comprises one or more touch zones.

14. The apparatus of claim 12, wherein the stabilized aviation operations interface component comprises one or more remapped touch zones.

15. The apparatus of claim 12, wherein the one or more processors are further configured to:
identify predicted aviation operations impact data; and
determine that the aircraft is predicted to be impacted by the aviation instability event based on the predicted aviation operations impact data.

16. The apparatus of claim 12, wherein the one or more processors are further configured to:
identify aviation operations data;
generate an aviation operations interface component based on the aviation operations data, wherein the aviation operations interface component comprises one or more aviation operations display items; and
cause the aviation operations interface component to be rendered on the aviation operations interface.

17. The apparatus of claim 12, wherein the aviation instability event is one or more of a landing associated with the aircraft, a takeoff associated with the aircraft, weather associated with the aircraft, or turbulence associated with the aircraft.

18. The apparatus of claim 12, wherein the device is a flight management system, an electronic flight bag, or a multi-function control and display unit.

19. The apparatus of claim 12, wherein the aviation stability adjustment data is representative of an estimated position change of an eye gaze of an operator of the aircraft.

20. A computer program product comprising at least one non-transitory computer-readable storage medium having computer program code stored thereon that, in execution with at least one processor, configures the computer program product for:
receiving aviation operations display data associated with an aircraft;
capturing aviation operations impact data using one or more aircraft components of the aircraft, wherein the aviation operations impact data is indicative of an aviation instability event;
generating aviation stability adjustment data by applying the aviation operations impact data to an aviation stability adjustment model;
generating a stabilized aviation operations interface component based on the aviation stability adjustment data and the aviation operations display data, wherein the stabilized aviation operations interface component comprises one or more stabilized aviation operations display items; and
causing the stabilized aviation operations interface component to be rendered to an aviation operations interface of a device.
